(19) United States
(12) Patent Application Publication
(10) Pub. No.: US 2023/0146749 A1
(43) Pub. Date: May 11, 2023

(54) IMPROVEMENTS IN INTEGRAL DOUBLE-WALLED CONTAINERS

(71) Applicant: ALAN MARK CRAWLEY, BLENHEIM (NZ)

(72) Inventor: ALAN MARK CRAWLEY, BLENHEIM (NZ)

(21) Appl. No.: 17/906,457

(22) PCT Filed: Mar. 16, 2021
(86) PCT No.: PCT/IB2021/052178

§ 371 Date: Sep. 15, 2022

(30) Foreign Application Priority Data
Mar. 17, 2020 (NZ) 762703

(51) Int. Cl. B65D 81/26; B65D 1/40; B65D 81/38

(52) U.S. Cl. CPC B65D 81/262; B65D 1/40; B65D 81/3869

(57) ABSTRACT

A double-walled container apparatus 12 with the structure of two integrally connected and adjacent containers 14 and 15 extending in the same direction with an air gap 16 between them, formed as a single body out of thermoformable material, and of a thin-walled nature suitable for mass-production, and whereby at least one or more apertures 13 are formed in at least one or more container walls to enable egression of fluids. A double-walled container apparatus 12 may have an upper lid 18 and/or a double-walled container apparatus 12 may have a lower lid 20.

### FIELD OF THE INVENTION

This invention relates to mass-producible integral double-walled containers, formed as single bodies from thermoformable material with the structure of two integrally connected and adjacent containers extending in the same direction with an air gap between them, and having at least one or more apertures for the egress of flowable materials.

### BACKGROUND OF THE INVENTION

According to Wikipedia, a container is “a basic tool consisting of any device creating a partially or fully enclosed space that can be used to contain, store, and transport objects or materials”.

As used herein, a container may be a beaker, bottle, bowl, canteen, cap, carafe, carton, clam-shell, cover, cup, fast-food container, food container, glass, hood, lid, mug, plate, pot or tumbler, or any other derivative of container denoting a partially or fully enclosed space capable of holding liquid and/or solid content.

As used herein, the term aperture denotes an opening, hole or gap, and may equally be substituted with cut, orifice, outlet, passage, perforation, pinhole, puncture, slit, slot, space or vent, or any other derivative of aperture denoting a means of egress for flowable materials.

As used herein, the term “thermoformable material” denotes any material suitable for heat-softening, and while in a heat-softened state, suitable for reforming under the application of pressure into alternate shapes/forms via any known heat-forming means, including but not limited to the process of thermoforming as well as the process of blow-forming.

There are countless low-cost containers made globally each year which are suitable for mass-production. Issues relating to low-cost production include but are by no means limited to:
Low cost thermoformable materials,
Thin wall sections/light empty-weight,
High production speed,
Small production line footprint to enable small-cell production facilities that can be located adjacent to distribution centres, thereby minimising logistics costs,
High degree of recyclability,
Maximising stackability to minimise logistics and storage costs,
Small number of production processes.

Currently, almost all mass-produced containers are single-walled by nature. The prime reasons are that current production processes are either incapable of making integral double-walled containers, or any production method currently utilised that may be capable of producing integral double-walled containers results in commercially cost-prohibitive per unit piece costs, primarily due to the resulting containers having thick walls and therefore prohibitively high material costs.

There are any number of market-driven reasons for the likes of cost-effective integral double-walled container with the structure of two integrally connected and adjacent containers with an air gap between them and formed as a single body, including but not limited to:
The formation of a fully recyclable coffee cup,
The formation of a cold cup that does not form condensation on outside walls,
The formation of a cold cup that extends beverage shelf life,
The formation of a cold cup that extends ice retention,
The formation of containers that extend the period that contents remain hot and/or cold,
The formation of containers that extend the shelf-life of its contents,
The formation of containers that extend the life of potted plants,
Any combination thereof, or
Any other market-driven reasons obvious to those versed in the art.

While shelf-life is typically not an issue for beverage contents, it is an issue for food related contents, including but by no means limited to vegetables, salads and fruit, whether raw or cooked.

Each year, a staggering amount of food globally is wasted due to fluid-related damage while in storage, both at point of sale and in storage at or within a home environment.

The typical means of damage include but are by no means limited to:
Residual water on the likes of vegetables and/or salads retained on the surface due to washing prior to storage, and then once placed in container storage, the water drains to the bottom of the container where it causes the food to discolour and/or rot,
The juices from the likes of fruit placed in container storage, whereby juice drains to the bottom of the container and causes the food to discolour and/or rot.

While fluid build-up in the bottom of food storage containers is responsible for significant food loss each year globally, it is not the only area of fluid build-up in integral double-walled containers. During the wash-cycle of reusable container formats such as containers with integral double-walls, there is the potential for unwanted fluid to build up within the air gap, and when integral double-walled containers are used as plant pots, there is the need to drain fluid out of the plant storage area in order to maintain healthy plant life.

A cost-effective solution is therefore required for the efficient removal of fluid build-up in integral double-walled containers.

### BRIEF DESCRIPTION OF THE PRIOR ART

U.S. Pat. No. 9,339,979 teaches a double-walled thermal barrier cup thermoformed as a single piece out of thermoplastic material with at least one rib maintaining partial spacing between inner and outer walls, and with the as-formed cup having a sealed insulation space.

PCT/IB2017/056558 teaches a method for producing a double-walled container with the structure of two integrally connected and adjacent containers extending in the same direction with an air gap between them, and wherein the inversion of a second container is executed while fully enclosed inside of a mould having a dual-container shaped cavity configuration.

However, inversion as taught may result in the inverted second container wall exceeding the materials elastic limit and thereby wall damage may occur.

PCT/IB2019/050684 teaches a method for producing a double-walled container with the structure of two integrally connected and adjacent containers extending in the same direction with an air gap between them, and wherein the inversion of the second container is executed by means whereby the material elastic limit is not exceeded and thereby wall damage does not occur.

While all three prior art teach integral double-walled containers that can be mass-produced, none teach means of fluid egression.

The object of the present invention is to overcome some of the disadvantages with integral double-walled containers with the structure of two integrally connected and adjacent containers with an air gap between them and formed as single bodies whereby unwanted fluid may build up in one or more place, and/or fluid may be required to drain out during the course of usage.

### SUMMARY OF THE INVENTION

In accordance with a first aspect of the present invention there is provided a double-walled container apparatus with the structure of two integrally connected and adjacent containers extending in the same direction with an air gap between them, formed as a single body out of thermoformable material, and of a thin-walled nature suitable for mass-production, and whereby at least one or more apertures are formed in at least one or more container walls to enable egression of fluids.

There are many ways to form double-walled containers, including but by no means limited to:
Blow-forming as a thick-walled integral structure by means of extrusion blow moulding and then at least partially inverting some of the as-blown structure,
Thermoforming as two separate containers then joining together, such as by means of spin welding, and
Blow-forming as a thin-walled integral structure by means of stretch blow moulding and then at least partially inverting some of the as-blown structure, as taught in prior art PCT/IB2019/050684.

In order to be cost effective for mass-production applications, an integral double-walled container needs to be:
Formed as a single body,
Have the thinnest viable wall thickness possible, and
Have a high degree of wall thickness uniformity.

The preferred means of production is therefore by stretch blow moulding and at least partially inverting some of the as-blown structure as taught in prior art PCT/IB2019/050684, however any economically viable means of producing integral double-walled containers with thin walls known to those versed in the art may equally be employed.

The intent is for the integral double-walled container to have highly uniform average wall thicknesses of less than 1 mm, and preferably between 0.10 and 0.5 mm.

Factoring in thermoformable material costs and ease of recyclability, the preferred material is polypropylene (PP), however depending on the integral double-walled container's specific market application, any thermoformable material may equally be used.

The thermoformable material used may be oil based or bio-based, clear/transparent, semi-transparent or opaque, of its natural resin colour or of any colour or combination of colours to suit an application, a single resin type or a blend of resin types, a single layer of one resin or multiple layers of alternate resins, or any combination thereof.

For high speed production, it is typically preferable to have a larger number of quick steps in a production sequence rather than a smaller number of slower steps, as for any production sequence, overall production throughput is typically determined by the slowest step.

It is therefore preferable for the means of addition of one or more apertures in an integral double-walled container to not cause any reduction in production-line throughput. The addition of the one or more apertures may be:
During the actual forming process of the integral double-walled container, or
As a separate step after the formation of the integral double-walled container.

The means of addition of the one or more apertures may include, but is by no means limited to:
Punching,
Drilling,
Routing,
Heat staking,
Laser cutting,
Cutting by any sharp edge,
Any combination thereof,
Or by any other means apparent to those versed in the art.

There may be one or more apertures in only one wall of the container, or there may be one or more apertures in multiple container walls.

The one or more apertures may be of any shape or form, in any location or locations, in geometric and/or non-geometric patterns, or any combination thereof.

The one or more apertures may be flush with the container wall surface, recessed into the container wall surface, protrude outwards from the container wall surface, or any combination thereof for any means or purpose.

An integral double-walled container with at least one aperture for the egression of fluid may have means of engagement of one or more lids. One lid may engage with and at least partially seal the upper opening through which contents are introduced into the container. One lid may engage with and at least partially seal any lower bottom opening of an integral double-walled container.

In a first preferred embodiment, there is provided a double-walled container with the structure of two integrally connected and adjacent containers extending in the same direction with an air gap between them, formed as a single body out of thermoformable material, and of a thin-walled nature suitable for mass-production, and whereby at least one or more apertures are formed in at least one the container wall in the region of the air gap to enable unwanted fluids in the air gap to egress.

Typically, the build-up of unwanted fluids in the air gap are due to automatic machine washing and/or hand-washing of integral double-walled containers prior to reuse. Particularly with automatic machine washing, containers are typically placed contents-opening in a downwards direction thereby exposing any potential accessway into the air gap to the ingression of water during the wash cycle.

While means to seal closed the air gap may be employed, such as by means of rib-features at least partially or fully closing off the air gap, the application of any known welding techniques, the application of additional sealing elements or sealants of any known form, or any combination thereof, water may still find its way into the air gap.

Obviously if there is a pathway for fluid to enter an air gap, equally there is means of fluid egression, however by providing at least one or more apertures in at least one wall of integral double-walled containers in the region of the air gap, more efficient means of fluid egression is provided.

It is preferable for the means of addition of the one or more apertures in an integral double-walled container wall to not cause any reduction in production-line throughput. The addition of the one or more wall apertures may be:
During the actual forming process of the integral double-walled container, or
As a separate step after the formation of the integral double-walled container.

The means of addition of the one or more wall apertures in the region of the air gap may include, but is by no means limited to:
Punching,
Drilling,
Routing,
Heat staking,
Laser cutting,
Cutting by any sharp edge,
Any combination thereof,
Or by any other means apparent to those versed in the art.

The one or more apertures may be of any shape or form, in any location or locations, in geometric and/or non-geometric patterns, or any combination thereof.

The one or more apertures may be in an outer wall, an inner wall, or any combination thereof. The preferred wall for one or more apertures is the outer wall.

The one or more apertures may be flush with the container wall surface, recessed into the container wall surface, protrude outwards from the container wall surface, or any combination thereof for any means or purpose.

An integral double-walled container with at least one wall aperture for the egression of unwanted fluid build-up within the air gap may have means of engagement of one or more lids. One lid may engage with and at least partially seal the upper opening through which contents are introduced into the container. One lid may engage with and at least partially seal any lower bottom opening of an integral double-walled container.

In a second preferred embodiment, there is provided a double-walled container with the structure of two integrally connected and adjacent containers extending in the same direction with an air gap between them, formed as a single body out of thermoformable material, and of a thin-walled nature suitable for mass-production, and whereby at least one or more apertures are formed in at least one container wall adjacent to any means of air gap sealing in order to minimise the potential of unwanted fluids entering into the air gap.

Typically, the build-up of unwanted fluids in the air gap are due to automatic machine washing and/or hand-washing of integral double-walled containers prior to reuse. Particularly with automatic machine washing, containers are typically placed contents-opening in a downwards direction thereby exposing the accessway into the air gap to the ingression of water during the wash cycle.

Particular with automatic machine washing, this downwards direction disposition provides the possibility of fluid build-up in the bottom recess area of an integral double-walled container during the wash cycle and thereby increases the opportunity for unwanted fluid egression into the air gap.

While means to seal closed the air gap may be employed, such as by means of rib-features at least partially or fully closing off the air gap, the application of any known welding techniques, the application of additional sealing elements or sealants of any known form, or any combination thereof, water may still find its way into the air gap.

By providing at least one or more apertures adjacent to air gap sealing means, fluid build-up in the region of air gap sealing means is minimised and thereby in-turn, fluid egression into the air gap is also minimised.

It is preferable for the means of addition of the one or more apertures in an integral double-walled container wall to not cause any reduction in production-line throughput. The addition of the one or more wall apertures may be:
During the actual forming process of the integral double-walled container, or
As a separate step after the formation of the integral double-walled container.

The means of addition of the one or more wall apertures in the region of air gap sealing means may include, but are by no means limited to:
Punching,
Drilling,
Routing,
Heat staking,
Laser cutting,
Cutting by any sharp edge,
Any combination thereof,
Or by any other means apparent to those versed in the art.

The one or more apertures may be of any shape or form, in any location or locations, in geometric and/or non-geometric patterns, or any combination thereof.

The one or more apertures may be in an outer wall, an inner wall, or any combination thereof. The preferred wall for one or more apertures is the outer wall.

The one or more apertures may be flush with the container wall surface, recessed into the container wall surface, protrude outwards from the container wall surface, or any combination thereof for any means or purpose.

An integral double-walled container with at least one wall aperture in the region of air gap sealing means in order to minimise unwanted fluid ingressing into the air gap may have means of engagement of one or more lids. One lid may engage with and at least partially seal the upper opening through which contents are introduced into the container. One lid may engage with and at least partially seal any lower bottom opening of an integral double-walled container.

In a third preferred embodiment, there is provided a double-walled container with the structure of two integrally connected and adjacent containers extending in the same direction with an air gap between them, formed as a single body out of thermoformable material, and of a thin-walled nature suitable for mass-production, and whereby at least one or more apertures are formed in at least one container wall to enable fluids in the storage portion of the container to egress.

Typically, the build-up of fluids in the storage portion of a container are due to means that include:
Unwanted retained fluids, such as by example water, remaining on food surfaces due to washing prior to storage,
Unwanted juices emanating out of food in storage,
Water introduced into a plant pot to advance plant health that equally requires means of egression in order to maintain a long term healthy environment,
A combination thereof, or
Any other source of fluid obvious to those versed in the art.

By whatever means the fluid is derived, ultimately the effect is the same—the contents in storage experiences accelerated deterioration, whether it be the likes of food discolouration and/or rotting, a reduction in plant life etc.

It is preferable for the means of addition of the one or more apertures in an integral double-walled container wall to not cause any reduction in production-line throughput. The addition of the one or more wall apertures may be:
During the actual forming process of the integral double-walled container, or
As a separate step after the formation of the integral double-walled container.

The means of addition of the one or more wall apertures may include, but are by no means limited to:
Punching,
Drilling,
Routing,
Heat staking,
Laser cutting,
Cutting by any sharp edge,
Any combination thereof,
Or by any other means apparent to those versed in the art.

The one or more apertures may be of any shape or form, in any location or locations, in geometric and/or non-geometric patterns, or any combination thereof.

The one or more apertures may be in an outer wall, an inner wall, or any combination thereof. The preferred wall for one or more apertures is the inner wall.

The one or more apertures may be flush with the container wall surface, recessed into the container wall surface, protrude outwards from the container wall surface, or any combination thereof for any means or purpose.

An integral double-walled container with at least one wall aperture for the egression of fluid may have means of engagement of one or more lids. One lid may engage with and at least partially seal the upper opening through which contents are introduced into the container. One lid may engage with and at least partially seal the lower bottom opening of an integral double-walled container.

It will be apparent to those versed in the art that any combination of the preferred embodiments as taught are equally possible.

Further aspects of the invention, which should be considered in all its novel aspects, will become apparent from the following description, which is given by way of example only.

### BRIEF DESCRIPTION OF DRAWINGS

Examples of the invention will become apparent from the following description which is given by way of example with reference to the accompanying drawings which:

FIG. 1 shows a three-dimensional cross-section view of an integral double-walled container with at least one aperture in a wall in the region of the air gap according to a first preferred embodiment of the present invention;

FIG. 2 shows a three-dimensional full view of the same integral double-walled container of FIG. 1 with at least one aperture in a wall in the region of the air gap;

FIG. 3 shows a three-dimensional cross-section view of an integral double-walled container with at least one aperture in a wall adjacent to air gap sealing means in a contents-opening downwards disposition according to a second preferred embodiment of the present invention;

FIG. 4 shows a three-dimensional full view of the same integral double-walled container of FIG. 3 with at least one aperture in a wall adjacent to air gap sealing means in a contents-opening downwards disposition;

FIG. 5 shows a three-dimensional cross-section view of an integral double-walled container in the form of a bowl with at least one aperture in a wall and with upper and lower lids according to a third preferred embodiment of the present invention; and

FIG. 6 shows a three-dimensional cross-section view of an integral double-walled container in the form of a plant pot with at least one aperture in a wall according to the same third preferred embodiment of the present invention.

### DETAILED DESCRIPTION

It will be appreciated that terminology such as “downwards” and “outwards”, “upper” and “lower” etc. as used in this specification refer to the orientations shown in the drawings and orientations obvious to those versed in the art. The terms are used to indicate relative orientations but should not be considered to be otherwise limiting.

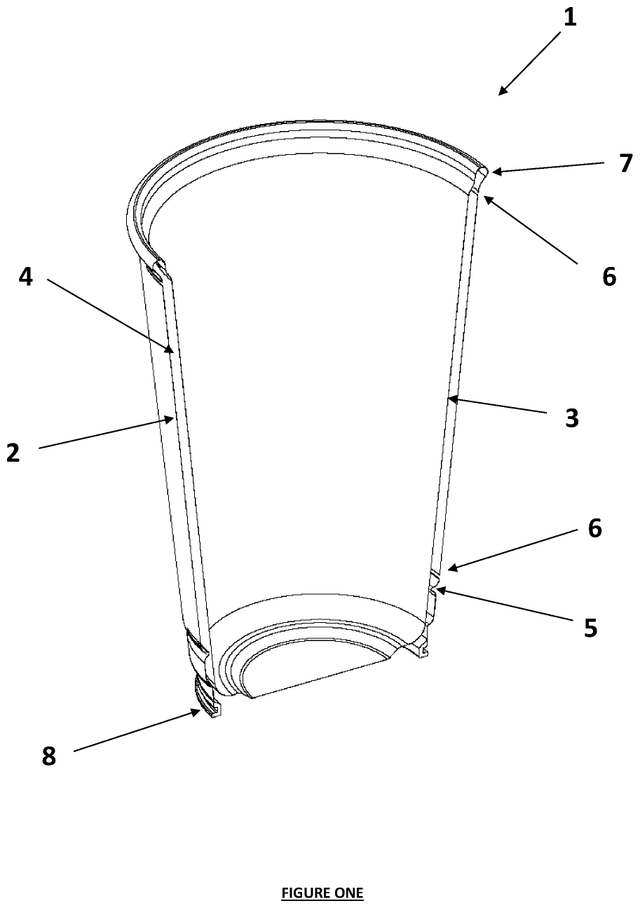

Referring to FIG. 1, a three-dimensional cross-section view of an integral double-walled container 1 with at least one wall aperture 6 in the region of the air gap 4 is depicted according to a first preferred embodiment of the present invention.

The integral double-walled container 1 as depicted has the structure of two integrally connected and adjacent containers 2 and 3 extending in the same direction with an air gap 4 between them, formed as a single body out of thermoforming material, and of a thin-walled nature suitable for mass-production, and whereby at least one or more apertures 6 are formed in at least one container wall in the region of the air gap 4 to enable unwanted fluids in the air gap 4 to egress.

Typically, the build-up of unwanted fluids in an air gap 4 are due to automatic machine washing and/or hand-washing of integral double-walled containers prior to reuse. Particularly with automatic machine washing, containers are typically placed contents-opening in a downwards direction thereby exposing any potential accessway into the air gap 4 to the ingression of water during the wash cycle (not depicted).

While means to seal closed the air gap 4 may be employed, such as by means of rib-features 5 at least partially or fully closing off the air gap 4 (as depicted), the application of any known welding techniques, the application of additional sealing elements or sealants of any known form, or any combination thereof, unwanted fluid may still find its way into the air gap 4.

Obviously if there is a pathway for unwanted fluid to enter an air gap 4, equally there is means of fluid egression, however by providing at least one or more apertures 6 in at least one wall of an integral double-walled container 1 in the region of the air gap 4, more efficient means of fluid egression is provided.

It is preferable for the means of addition of the one or more apertures 6 in an integral double-walled container 1 wall to not cause any reduction in production-line throughput. The addition of the one or more wall apertures 6 may be:
During the actual forming process of the integral double-walled container, or
As a separate step after the formation of the integral double-walled container.

The means of addition of the one or more wall apertures 6 in the region of the air gap 4 may include, but is by no means limited to:
Punching,
Drilling,
Routing,
Heat staking,
Laser cutting,
Cutting by any sharp edge,
Any combination thereof,
Or by any other means apparent to those versed in the art.

The one or more apertures 6 may be of any shape or form, in any location or locations, in geometric and/or non-geometric patterns, or any combination thereof.

The one or more apertures 6 may be in an outer wall 2, an inner wall 3, or any combination thereof. The preferred wall for one or more apertures 6 is the outer wall 2 as depicted.

The one or more apertures 6 may be flush with the container wall surface (as depicted), recessed into the container wall surface, protrude outwards from the container wall surface, or any combination thereof for any means or purpose.

An integral double-walled container 1 with at least one aperture 6 for the egression of unwanted fluid build-up within the air gap 4 may have means of engagement of one or more lids. One lid (not depicted) may engage with and at least partially seal the upper opening through which contents are introduced into the container 7. One lid (not depicted) may engage with and at least partially seal any lower bottom opening 8 of an integral double-walled container.

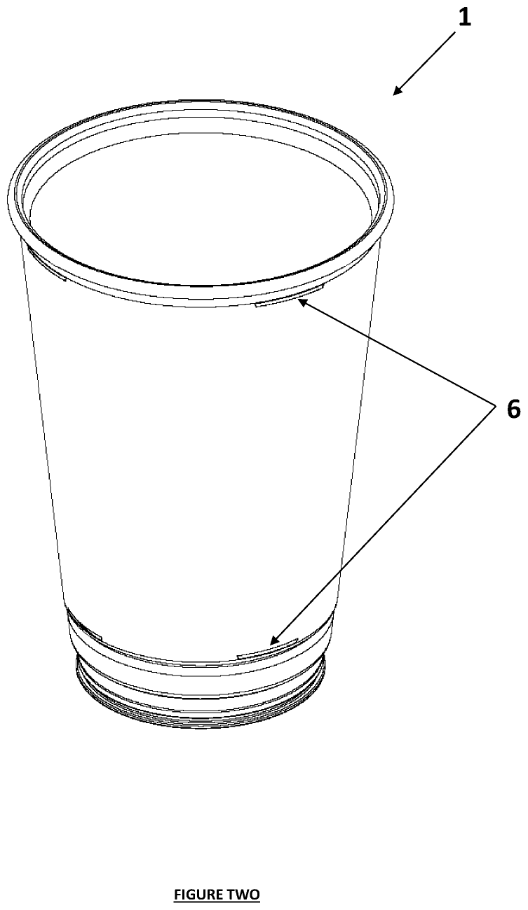

Referring to FIG. 2, the same integral double-walled container 1 of FIG. 1 is depicted as a three-dimensional full view in order to better illustrate the at least one container wall aperture 6.

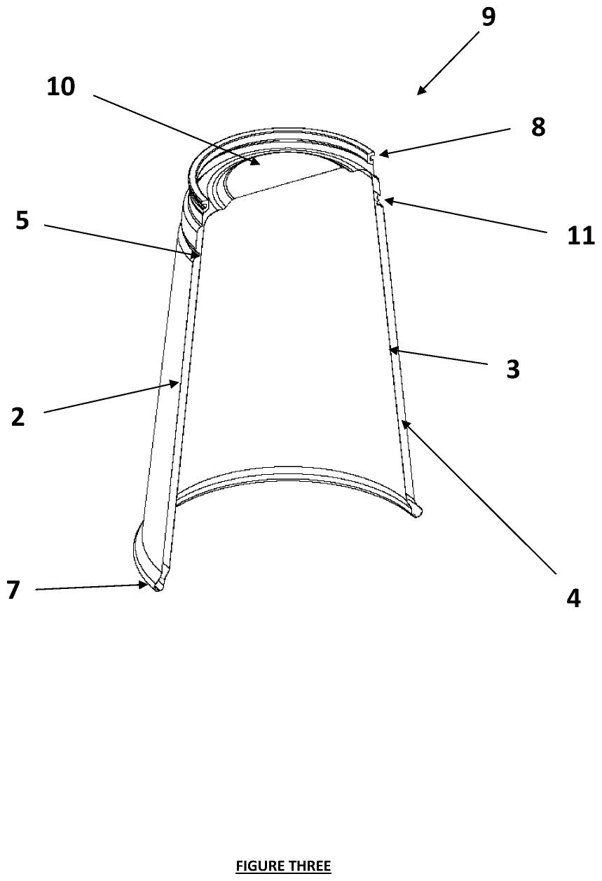

Referring to FIG. 3, a three-dimensional cross-section view of an integral double-walled container 9 is depicted in a contents-opening 7 disposed downwards direction with at least one aperture 11 adjacent to air gap sealing means 5 according to a second preferred embodiment of the present invention

The integral double-walled container 9 as depicted has the structure of two integrally connected and adjacent containers 2 and 3 extending in the same direction with an air gap 4 between them, formed as a single body out of thermoformable material, and of a thin-walled nature suitable for mass-production, and whereby at least one or more apertures 11 are formed in at least one container wall adjacent to any means of air gap sealing 5 in order to minimise the potential of unwanted fluids entering into the air gap 4.

Typically, the build-up of unwanted fluids in the air gap 4 are due to automatic machine washing and/or hand-washing of integral double-walled containers 9 prior to reuse. Particularly with automatic machine washing, containers are typically placed contents-opening 7 in a downwards direction as depicted, thereby exposing the accessway into the air gap 4 to the ingression of water during the wash cycle.

Particular with automatic machine washing, this downwards direction disposition provides the possibility of fluid build-up in the lower bottom recess area 10 of an integral double-walled container 9 during the wash cycle and thereby increases the opportunity for unwanted fluid egression into the air gap 4.

While means to seal closed the air gap 4 may be employed, such as by means of rib-features 5 at least partially or fully closing off the air gap (as depicted), the application of any known welding techniques, the application of additional sealing elements or sealants of any known form, or any combination thereof, unwanted fluid may still find its way into the air gap 4.

By providing at least one or more apertures 11 adjacent to air gap sealing means 5, fluid build-up in the bottom recess region 10 of air gap sealing means 5 is minimised and thereby in-turn, fluid egression into the air gap 4 is also minimised.

It is preferable for the means of addition of the one or more apertures 11 in an integral double-walled container 9 wall to not cause any reduction in production-line throughput. The addition of the one or more wall apertures 11 may be:
During the actual forming process of the integral double-walled container, or
As a separate step after the formation of the integral double-walled container.

The means of addition of the one or more wall apertures 11 in the region of air gap sealing means 5 may include, but are by no means limited to:
Punching,
Drilling,
Routing,
Heat staking,
Laser cutting,
Cutting by any sharp edge,
Any combination thereof,
Or by any other means apparent to those versed in the art.

The one or more apertures 11 may be of any shape or form, in any location or locations, in geometric and/or non-geometric patterns, or any combination thereof.

The one or more apertures 11 may be in an outer wall 2, an inner wall 3, or any combination thereof. The preferred wall for one or more apertures 11 is the outer wall 2 as depicted.

The one or more apertures 11 may be flush with the container wall surface (as depicted), recessed into the container wall surface, protrude outwards from the container wall surface, or any combination thereof for any means or purpose.

An integral double-walled container 9 with at least one wall aperture 11 in the region of air gap sealing means 5 in order to minimise unwanted fluid ingressing into the air gap 4 may have means of engagement of one or more lids. One lid (not depicted) may engage with and at least partially seal the upper opening through which contents are introduced into the container 7. One lid (not depicted) may engage with and at least partially seal any lower bottom opening 8 of an integral double-walled container 9.

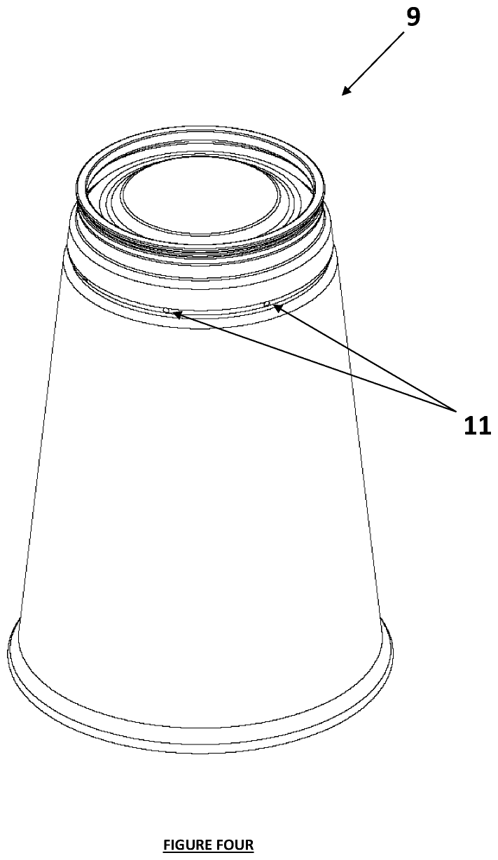

Referring to FIG. 4, the same integral double-walled container 9 of FIG. 3 is depicted as a three-dimensional full view in order to better illustrate the at least one container wall aperture 11.

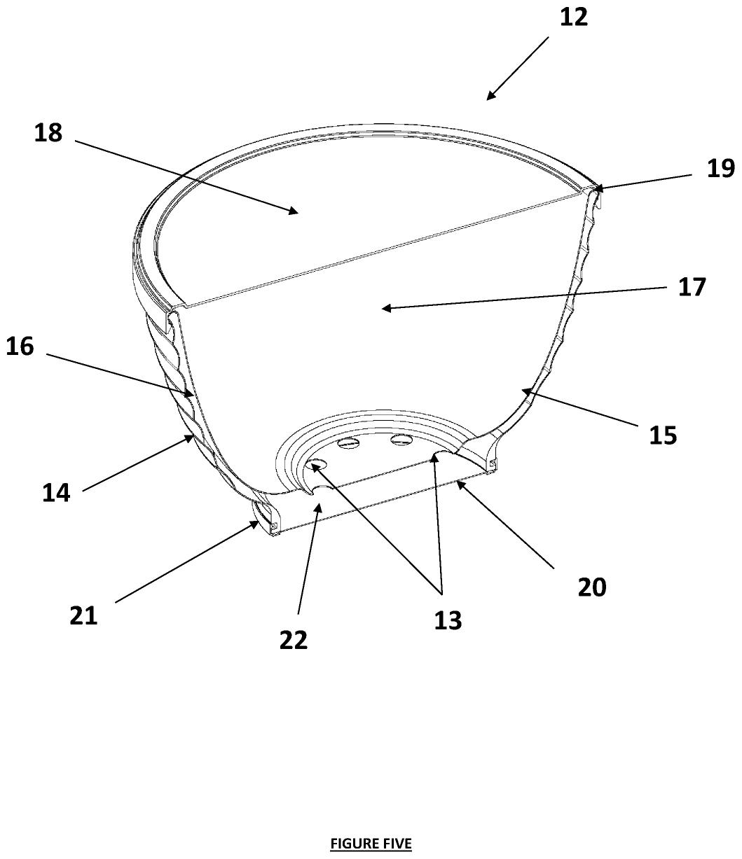

Referring to FIG. 5, a three-dimensional cross-section view of an integral double-walled container in the form of a bowl 12 is depicted with at least one aperture 13 in at least one wall is depicted according to a third preferred embodiment of the present invention.

The integral double-walled container as depicted 12 has the structure of two integrally connected and adjacent containers 14 and 15 extending in the same direction with an air gap 16 between them, formed as a single body out of thermoformable material, and of a thin-walled nature suitable for mass-production, and whereby at least one or more apertures 13 are formed in at least one container wall to enable unwanted fluids in the storage portion of the container 17 to egress.

Typically, the build-up of unwanted fluids in the storage portion of a container 17 are due to means that include:
Retained fluids, such as by example water, remaining on food surfaces due to washing prior to storage,
Juices emanating out of food in storage,
A combination thereof, or
Any other source of fluid build-up obvious to those versed in the art.

By whatever means the fluid is derived, ultimately the effect is the same—the contents in storage experiences accelerated deterioration, such as the likes of food discolouration and/or rotting etc.

It is preferable for the means of addition of the one or more apertures 13 in an integral double-walled container wall to not cause any reduction in production-line throughput. The addition of the one or more wall apertures 13 may be:
During the actual forming process of the integral double-walled container, or
As a separate step after the formation of the integral double-walled container.

The means of addition of the one or more wall apertures 13 may include, but are by no means limited to:
Punching,
Drilling,
Routing,
Heat staking,
Laser cutting,
Cutting by any sharp edge,
Any combination thereof,
Or by any other means apparent to those versed in the art.

The one or more apertures 13 may be of any shape or form, in any location or locations, in geometric and/or non-geometric patterns, or any combination thereof.

The one or more apertures 13 may be in an outer wall 14, an inner wall 15, or any combination thereof. The preferred wall for one or more apertures 13 is the inner wall 15 as depicted.

The one or more apertures 13 may be flush with the container wall surface (as depicted), recessed into the container wall surface, protrude outwards from the container wall surface, or any combination thereof for any means or purpose.

An integral double-walled container 12 with at least one wall aperture 13 for the egression of unwanted fluid build-up may have means of engagement of one or more lids. One upper lid 18 may engage with and at least partially seal the upper opening through which contents are introduced into the container 19. One lower lid 20 may engage with and at least partially seal the lower bottom opening 21 of an integral double-walled container 12.

The addition of a lower lid 20 adjacent to the bottom opening 21 of an integral double-walled container 12 may serve the purpose of at least partially sealing of the air gap 16 thereby providing a catchment area 22 for any unwanted fluids as they egress out of the storage portion of the container 17 by means of the at least one or more apertures 13.

This provision of a catchment area 22 might be advantageous during both point-of-sale as well as home-storage applications for food related items in that the egression of unwanted fluids is isolated from the food in storage until released by a user, and for the likes of fruit juices as by example only, enables a user to collect and retain the fluid for other purpose if so desired, without causing damage to the stored contents.

Lids may be of any known means to at least partially seal off the air gap 16, including but not limited to:
Physical lids 18 and 20 as depicted,
Thin-walled membranes that attach by any known means including gluing, heat welding or ultrasonic welding,
The placing of the whole integral double-walled container 12 in a separate sealed environment such as in a plastic bag or the like,
Any combination thereof,
Or any other means of sealing obvious to those versed in the art.

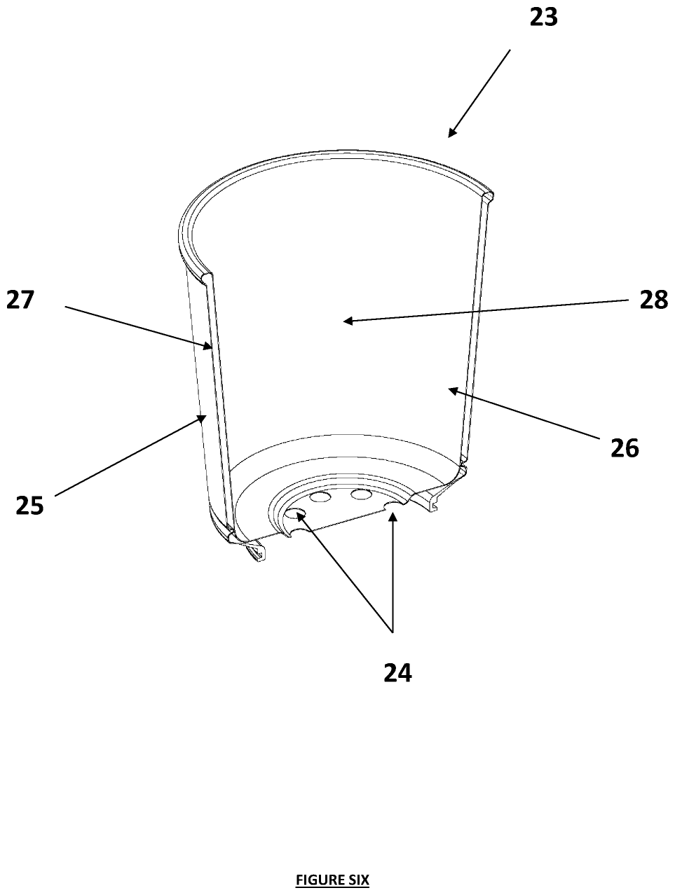

Referring to FIG. 6, a three-dimensional cross-section view of an integral double-walled container in the form of a plant pot 23 is depicted with at least one aperture 24 in at least one wall is depicted according to the same third preferred embodiment of the present invention.

The integral double-walled container as depicted 23 has the structure of two integrally connected and adjacent containers 25 and 26 extending in the same direction with an air gap 27 between them, formed as a single body out of thermoformable material, and of a thin-walled nature suitable for mass-production, and whereby at least one or more apertures 24 are formed in at least one container wall to enable fluids in the storage portion of the container 28 to egress.

For the likes of plant pots, fluids such as water are not unwanted, however for long-term plant health, means of drainage of fluids out of the container storage area 28 is a necessary part of plant protection.

It is preferable for the means of addition of the one or more apertures 24 in an integral double-walled container 23 wall to not cause any reduction in production-line throughput. The addition of the one or more wall apertures 24 may be:
During the actual forming process of the integral double-walled container, or
As a separate step after the formation of the integral double-walled container.

The means of addition of the one or more wall apertures 24 may include, but are by no means limited to:
Punching,
Drilling,
Routing,
Heat staking,
Laser cutting,
Cutting by any sharp edge,
Any combination thereof,
Or by any other means apparent to those versed in the art.

The one or more apertures 24 may be of any shape or form, in any location or locations, in geometric and/or non-geometric patterns, or any combination thereof.

The one or more apertures 24 may be in an outer wall 25, an inner wall 26, or any combination thereof. The preferred wall for one or more apertures 24 is the inner wall 26 as depicted.

The one or more apertures 24 may be flush with the container wall surface (as depicted), recessed into the container wall surface, protrude outwards from the container wall surface, or any combination thereof for any means or purpose.

It will be apparent to those versed in the art that any combination of the preferred embodiments as taught are equally possible.

Where in the foregoing description reference has been made to integers or components having known equivalents, then such equivalents are herein incorporated as if individually set forth.

Although this invention has been described by way of example and with reference to possible embodiments thereof, it is to be appreciated that improvements and/or modifications may be made thereto without departing from the scope or spirit of the invention. Any one or more elements that comprise any embodiment may equally be combined in any order into further embodiments readily apparent to those versed in the art.

What is claimed is:

1. A double-walled container apparatus with the structure of two integrally connected and adjacent containers extending in the same direction with an air gap between them, formed as a single body out of thermoformable material, and of a thin-walled nature suitable for mass-production, and whereby at least one or more apertures are formed in at least one or more container walls to enable egression of fluids.

2. An apparatus according to claim 1, wherein at least one or more apertures are formed in at least one container wall in the region of the air gap to enable unwanted fluids in the air gap to egress

3. An apparatus according to claim 1, wherein at least one or more apertures are formed in at least one container wall adjacent to any means of air gap sealing in order to minimise the potential of unwanted fluids entering into the air gap.

4. An apparatus according to claim 1, wherein at least one or more apertures are formed in the container inner wall to enable fluids in the storage portion of the container to egress.

5. An aperture according to all previous claims, wherein the means of addition of any one or more apertures may include, but are by no means limited to punching, drilling, routing, heat staking, laser cutting, cutting by any sharp edge, any combination thereof, or by any other means apparent to those versed in the art.

6. An aperture according to all previous claims, wherein the one or more apertures may be of any shape or form, in any location or locations, in geometric and/or non-geometric patterns, or any combination thereof.

7. An aperture according to all previous claims, wherein the one or more apertures may be flush with the container wall surface, recessed into the container wall surface, protrude outwards from the container wall surface, or any combination thereof for any means or purpose.
